(19) United States
(12) Patent Application Publication
(10) Pub. No.: US 2006/0265509 A1
(43) Pub. Date: Nov. 23, 2006

(54) Methods and systems for communicating voice, audio, video, text and/or multimedia data

(76) Inventor: Shrihari B. Pandit, Brooklyn, NY (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 11/409,286

(22) Filed: Apr. 21, 2006

Related U.S. Application Data
(60) Provisional application No. 60/674,388, filed on Apr. 22, 2005.

(51) Int. Cl. G06F 15/16

(52) U.S. Cl. 709/230

(57) ABSTRACT

Systems and methods for providing peer-to-peer voice, audio, video, text and/or multimedia communications between subscriber hosts over a private packet-switched network communicating data pursuant to a first protocol are provided. Routing data is distributed to a plurality of voice, audio, video, text and/or multimedia-communication hosts coupled to the private network sufficient to enable peer-to-peer data communications therebetween pursuant to a second protocol, each of the plurality of voice, audio, video, text and/or multimedia-communication hosts having a unique second protocol address for communication pursuant to the second protocol. A second protocol address is communicated by means of a user identifier translation application running on a host coupled with the private network to a respective one of the plurality of voice, audio, video, text and/or multimedia communication hosts in response to a user identifier identifying a system user.

This application claims priority to U.S. provisional patent application Ser. No. 60/674,388, filed Apr. 22, 2005, which is hereby incorporated herein by reference in its entirety.

The present invention relates to communication of voice, audio, video, text and/or multimedia data over a network.

Since the invention of the telephone by Alexander Graham Bell, we have been looking for ways to communicate faster and more effective electronically. The traditional telephone network limits our communication capabilities, slowing the convergence of voice, video and data traffic. In the new electronic world, systems must be able to communicate with one another directly without other systems in the communication path in order to enable the full potential of communications.

To further explain, two people who speak English may carry out a conversation directly without the need for a translator or other intermediary; this is “peer-to-peer” communications. In today's telephone networks, there are many devices or elements that switch a call in order to complete a telephone call from a point to another. This design limits the communication capabilities to what is commonly supported in the elements between the end-points; if these devices were people (going to our earlier analogy), the devices would need to understand and support English or any language that the two people choose to speak.

With the transition of analog voice to Voice-over-IP (VOIP), this latest technology is enabling us to communicate not only audio but with video and other multimedia data and which can be integrated with our computer systems allowing us to work and use time more efficiently.

Unfortunately this new technology is being deployed in architectures similar to that of the traditional telephone network with multiple devices or elements that cannot enable peer-to-peer communications between two end-points.

Today systems that are implementing this new technology communicate with one and other via the traditional telephone network. This process converts the digital VOIP communications to analog and visa-versa to complete a call, thus downgrading the capability of the communications.

What is needed is the ability to enable communication systems to establish and conduct peer-to-peer communications for the exchange of voice, video, text and multimedia traffic.

### BRIEF DESCRIPTION OF THE DRAWINGS

FIG. 1 is a block diagram illustrating a system for communicating voice, audio, video, text and/or multimedia data between subscribers over a packet-switched network.

FIG. 2 is a further block diagram illustrating a system for communicating voice, audio, video, text and/or multimedia data between subscribers over a packet-switched network.

### SUMMARY AND DETAILED DESCRIPTION OF CERTAIN ADVANTAGEOUS EMBODIMENTS

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular network or inter-network.

The term “private network” as used herein means a network whose access is controlled by an administrator.

The terms “communicate,” “communicating” and “communication” as used herein include both conveying data from a source to a destination, and delivering data to a communications medium, system, device or link to be conveyed to a destination.

The term “level” as used herein and as applied to a communications protocol refers to a position of the communication protocol in a hierarchy of communication protocols in which a service operating pursuant to a lower level protocol provides communication services to a service operating pursuant to a higher level protocol.

The term “peer-to-peer” as used herein to qualify the terms “communicate”, “communicating” or “communication” shall include communicating or a communication between two devices at a predetermined level without the use of a further device at the same level in a communication path between the two devices.

The terms “first” and “second” are used to distinguish one element, set, data, object, step, process, activity or thing from another, and are not used to designate relative position or arrangement in time, unless otherwise stated explicitly.

The terms “coupled”, “coupled to”, and “coupled with” as used herein each mean a relationship between or among two or more devices, apparatus, files, programs, media, components, networks, systems, subsystems, and/or means, constituting any one or more of (a) a connection, whether direct or through one or more other devices, apparatus, files, programs, media, components, networks, systems, subsystems, or means, (b) a communications relationship, whether direct or through one or more other devices, apparatus, files, programs, media, components, networks, systems, subsystems, or means, and/or (c) a functional relationship in which the operation of any one or more devices, apparatus, files, programs, media, components, networks, systems, subsystems, or means depends, in whole or in part, on the operation of any one or more others thereof.

The term “database” as used herein means an organized body of related data, regardless of the manner in which the data or the organized body thereof is represented. For example, the organized body of related data may be in the form of a table, a map, a grid, a packet, a datagram, a file, a frame, a document, a list, a combination of two or more of the foregoing or in any other form.

The terms “storage” and “data storage” as used herein mean data storage devices, apparatus, programs, circuits, components, systems, subsystems and storage media serving to retain data, whether on a temporary or permanent basis, and to provide such retained data.

Certain embodiments include systems providing peer-to-peer voice, audio, video, text and/or multimedia communications between subscriber hosts over a private packet-switched network. The systems comprise a routing application running on a host coupled with a private network communicating data pursuant to a first protocol, the routing application being operative to distribute routing data to a plurality of voice, audio, video, text and/or multimedia-communication hosts coupled to the private network sufficient to enable peer-to-peer data communications therebetween pursuant to a second protocol, each of the plurality of voice, audio, video, text and/or multimedia-communication hosts having a unique second protocol address for communication pursuant to the second protocol; and a user identifier translation application running on a host coupled with the private network, the user identifier translation application being operative to communicate a second protocol address to a respective one of the plurality of voice, audio, video, text and/or multimedia communication hosts in response to a user identifier identifying a system user. In certain embodiments, the routing application and the user identifier translation application run on the same host. In certain embodiments, the routing application and the user identifier translation application run on different hosts.

Certain embodiments include methods for providing peer-to-peer voice, audio, video, text and/or multimedia-communications between subscriber hosts over a private packet-switched network communicating data pursuant to a first protocol. The methods comprise distributing routing data to a plurality of voice, audio, video, text and/or multimedia-communication hosts coupled to the private network sufficient to enable peer-to-peer data communications therebetween pursuant to a second protocol, each of the plurality of voice, audio, video, text and/or multimedia-communication hosts having a unique second protocol address for communication pursuant to the second protocol; and communicating a second protocol address by means of a user identifier translation application running on a host coupled with the private network to a respective one of the plurality of voice, audio, video, text and/or multimedia communication hosts in response to a user identifier identifying a system user.

Certain embodiments include methods for conducting voice, audio, video, text and/or multimedia communications using a host coupled to a private packet-switched network. The methods comprise using a first voice, audio, video, text and/or multimedia communications host coupled with a private packet-switched network, communicating with a host running a routing application to obtain routing data for communicating with a second voice, audio, video, text and/or multimedia communications host via the private packet-switched network pursuant to a predetermined protocol; using the first voice, audio, video, text and/or multimedia communications host, communicating a desired user identifier to a user identifier translation application to obtain a corresponding host address of a desired second voice, audio, video, text and/or multimedia communications host to communicate voice, audio, video, text and/or multimedia data thereto pursuant to the predetermined protocol; and communicating voice, audio, video, text and/or multimedia data on a peer-to-peer basis from the first voice, audio, video, text and/or multimedia communications host to the second voice, audio, video, text and/or multimedia communications host via the private packet-switched network using the host address pursuant to the predetermined protocol.

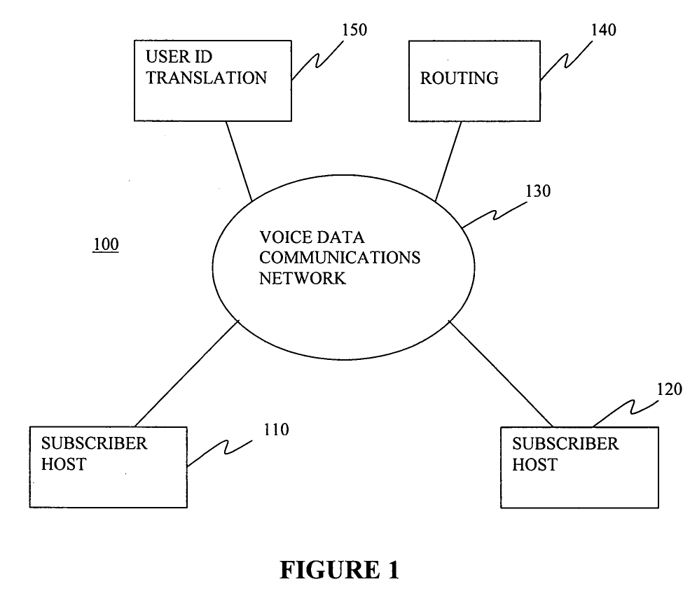

With reference to FIG. 1, a system 100 for providing peer-to-peer voice, audio, video, text and/or multimedia communications between subscriber hosts 110 and 120 over a private packet-switched network 130 is illustrated. The network 130 operates according to a predetermined first protocol to enable the communication of data packets between or among hosts coupled to the network and identified to one another by unique first protocol addresses. In certain embodiments, the first protocol comprises an Ethernet protocol. In certain embodiments, the first protocol comprises a point-to-point protocol (PPP), an FDDI protocol, an Asynchronous Transfer Mode (ATM) protocol, a Synchronous Transfer Mode (STM) protocol, a Dynamic synchronous Transfer Mode (DTM) protocol or a Frame Relay protocol.

Access by subscribers to the network 130 is controlled by an administrator. The administrator operates or controls the operation of a routing service 140 that enables hosts 110 and 120 to communicate voice, audio, video, text and/or multimedia data therebetween on a peer-to-peer basis. Service 140 provides routing information to the hosts 110 and 120 for conducting voice, audio, video, text and/or multimedia data communications according to a predetermined second protocol at a level higher than the first protocol to avail itself of network communications according to the first protocol. In certain embodiments, one or both of hosts 110 and 120 comprise a router providing access to the network 130 and a voice, audio, video, text and/or multimedia data communication application running on a single computer, while in certain embodiments, one or both of hosts 110 and 120 comprise a voice, audio, video, text and/or multimedia communication application running on one computer communicating with network 130 via a router running on a second computer.

In certain embodiments, the second protocol comprises an Internet Protocol (IP) and routing is accomplished by means of one or more IP routing devices (not shown for purposes of simplicity and clarity) coupled with the first protocol network. In certain ones of these embodiments, a BGP (Border Gateway Protocol) route reflector runs on a host (not shown for purposes of simplicity and clarity) coupled with the first protocol network and serves to exchange routing data with the IP routing devices in accordance with either Internet Engineering Task Force (IETF) RFC 4271. The BGP route reflector, communicating via the first protocol network, redistributes BGP routing data which it has obtained from the IP routing devices to various ones of the IP routing devices to establish peer-to-peer communications between the IP routing devices across the first protocol network.

The administrator also operates or controls the operation of a user identifier translation service 150 which accepts a user identifier from a subscriber host 110 or 120 and returns routing information, including a corresponding second level address, to the subscriber host for conducting voice, audio, video, text and/or multimedia data communications with a different one of the subscriber hosts 110 or 120 corresponding to the user identifier. In certain embodiments, the user identifier comprises a string, other than an IP address, comprised of letters and/or numbers, such as a string in the form of a telephone number.

In certain embodiments enabling voice and/or video communications between applications running on the subscriber hosts 110 and 120 and operating at a higher communications level than the second protocol, so that the second protocol is an Internet Protocol (IP), the routing information supplied by user identifier translation service 150 comprises a uniform resource identifier comprising an application protocol name and an IP address or hostname and the user identifier translation service 150 comprises an ENUM registry running on a host coupled with the first protocol network and storing user identifiers each with a corresponding uniform resource identifier. The ENUM registry operates according to IETF RFC 3761. In order to communicate voice and/or video data with another application on a peer-to-peer basis, each of the voice-over-IP systems queries the ENUM registry with the user identifier to retrieve a uniform resource identifier corresponding to the desired application.

In certain embodiments enabling voice, audio, video, text and/or multimedia communications between applications running on subscriber hosts 110 and 120 and operating at a higher communications level than the second protocol, the user identifier translation service 150 comprises an SRV registry running on a host coupled with the first protocol network that serves to translate an identifier containing service data such as an application protocol, a transport protocol and a domain name to a uniform resource identifier and operates in accordance with IETF RFC 2782.

In order to carry out peer-to-peer communications between applications running on hosts 110 and 120, one of the applications, such as an application running on host 110, queries the SRV registry by communicating an identifier comprising the necessary service data, including the domain name for host 120, thereto in order to retrieve the corresponding uniform resource identifier that will enable host 110 to initiate voice, audio, video, text and/or multimedia data communications on a peer-to-peer basis with host 120. As an example, if one wished to employ an application running on host 110 to communicate voice, audio, video, text and/or multimedia data to or from an application running on host 120, the application running on host 110 could query the SRV registry with an identifier such as “_sip_udp.domainofhost120.com” and would retrieve a uniform resource identifier therefrom such as “_sip_udp.domainofhost120.com SRV 0 0 5060 sip.domainofhost120.com.” The application running on host 110 would then communicate to sip.domainofhost120.com via UDP to port 5060.

Certain embodiments include systems providing peer-to-peer voice, audio, video, text and/or multimedia communications between OSI layer 3 devices over an OSI layer 2 network. The systems comprise a layer 3 routing application running on a layer 3 device, communicating layer 3 routing data, to a plurality of layer 3 devices over a layer 2 network sufficient to enable peer-to-peer data communications between layer 3 devices; a plurality of layer 3 communications devices, coupled with the layer 2 network, having at least one uniform resource identifier for communication pursuant to an OSI layer 4 or higher protocol; and a directory service application running on a layer 3 device coupled with the layer 2 network, the directory service application operative to communicate a uniform resource identifier to a respective one of the plurality of layer 3 communications devices in response to a user identifier identifying a system user.

Certain embodiments include methods for providing peer-to-peer voice, audio, video, text and/or multimedia communications between layer 3 devices over a layer 2 network communicating data pursuant to a layer 3 protocol. The methods comprise distributing layer 3 routing data to a plurality of layer 3 devices pursuant to a layer 3 routing protocol, coupled to the layer 2 network sufficient to enable peer-to-peer data communications therebetween pursuant to a layer 4 or higher protocol, each of the plurality of layer 3 communication devices having at least one uniform resource identifier for communication pursuant to the layer 4 or higher protocol; and communicating a uniform resource identifier by means of a directory service application running on a layer 3 device coupled with the layer 2 network to a respective one of the plurality of layer 3 communications host in response to a user identifier identifying a system user.

Certain embodiments include methods for conducting peer-to-peer voice, audio, video, text and/or multimedia data communications between layer 3 subscriber systems coupled with a layer 2 network. The methods comprise using a first layer 3 subscriber system coupled with the layer 2 network, communicating with a layer 3 system coupled with the layer 2 network and running a layer 3 routing application to obtain layer 3 routing data for communicating with a second layer 3 subscriber system via the layer 2 network pursuant to a layer 3 protocol; using the first layer 3 subscriber system, communicating a desired user identifier to a directory service application coupled with the layer 2 network to obtain a corresponding uniform resource identifier of a desired second layer 3 subscriber system to communicate voice, audio, video, text and/or multimedia data thereto pursuant to a layer 4 or higher protocol; and communicating voice, audio, video, text and/or multimedia data from the first layer 3 subscriber system to the desired second layer 3 subscriber system via the layer 2 network using the uniform resource identifier. In certain embodiments, the predetermined layer 3 protocol comprises an IP protocol, an IPv4 protocol, or an IPv6 protocol. In certain embodiments, the predetermined layer 4 or higher protocol comprises an SIP protocol, an H323 protocol, a WWW protocol, an MGCP protocol, an MPEG protocol, an MP3 protocol, a TCP protocol or a UDP protocol.

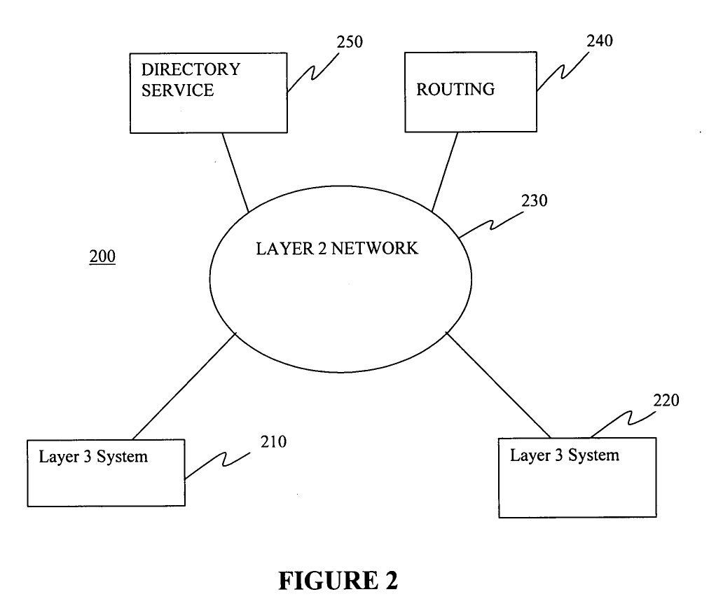

With reference to FIG. 2, a system 200 for providing peer-to-peer voice, audio, video, text and/or multimedia data communications between layer 3 systems 210 and 220 over a layer 2 network 230 is illustrated. The network 230 operates according to a predetermined layer 2 protocol to enable the communication of data packets between or among layer 3 devices connected to the network and identified to one another by unique layer 3 protocol address. In certain embodiments, the layer 3 systems 210 and/or 220 communicate directly with the layer 2 network, while in other embodiments, the layer 3 systems 210 and/or 220 communicate indirectly with the layer 2 network through one or more devices.

Access by subscribers to the network 230 is controlled by an administrator. The administrator operates or controls the operation of a layer 3 routing service 240 that enables systems 210 and 220 to communicate voice, audio, video, text and/or multimedia data therebetween on a peer-to-peer basis. Service 240 provides layer 3 routing information to the systems 210 and 220 for conducting voice, audio, video, text and/or multimedia data communications according to a predetermined level 3 protocol to avail itself of network communications according to the level 2 protocol. The coupling and exchange of layer 3 routing information of two layer 3 devices via the layer 2 network establishes a layer 3 network.

The administrator also operates or controls the operation of a directory service 250 which accepts a user identifier from the layer 3 subscriber system 210 or 220 and returns routing information, including a corresponding layer 3 protocol address, to the layer 3 communications system for conducting voice, audio, video, text and/or multimedia data communications with a different one of the layer 3 subscriber systems 210 or 220 corresponding to the user identifier, on a peer-to-peer basis across the layer 3 network.

What is claimed is:

1. A system for providing peer-to-peer voice, audio, video, text and/or multimedia communications between subscriber hosts over a private packet-switched network, comprising:
a routing application running on a host coupled with a private network communicating data pursuant to a first protocol, the routing application being operative to distribute routing data to a plurality of voice, audio, video, text and/or multimedia-communication hosts coupled to the private network sufficient to enable peer-to-peer data communications therebetween pursuant to a second protocol, each of the plurality of voice, audio, video, text and/or multimedia-communication hosts having a unique second protocol address for communication pursuant to the second protocol; and
a user identifier translation application running on a host coupled with the private network, the user identifier translation application being operative to communicate a second protocol address to a respective one of the plurality of voice, audio, video, text and/or multimedia communication hosts in response to a user identifier identifying a system user.

2. The system of claim 1, wherein the routing application and the user identifier translation application run on the same host.

3. The system of claim 1, wherein the routing application and the user identifier translation application run on different hosts.

4. A method for providing peer-to-peer voice, audio, video, text and/or multimedia communications between subscriber hosts over a private packet-switched network communicating data pursuant to a first protocol, comprising:
distributing routing data to a plurality of voice, audio, video, text and/or multimedia-communication hosts coupled to the private network sufficient to enable peer-to-peer data communications therebetween pursuant to a second protocol, each of the plurality of voice, audio, video, text and/or multimedia-communication hosts having a unique second protocol address for communication pursuant to the second protocol; and
communicating a second protocol address by means of a user identifier translation application running on a host coupled with the private network to a respective one of the plurality of voice, audio, video, text and/or multimedia communication hosts in response to a user identifier identifying a system user.

5. The method of claim 4, wherein the voice, audio, video, text and/or multimedia-communication hosts comprise a plurality of voice and/or video communication hosts.

6. The method of claim 5, wherein the voice and/or video communication hosts comprise a plurality of voice communication hosts.

7. The method of claim 5, wherein the voice and/or video communication hosts comprise a plurality of video communication hosts.

8. A method for conducting voice, audio, video, text and/or multimedia communications using a host coupled to a private packet-switched network, comprising:
using a first voice, audio, video, text and/or multimedia communications host coupled with a private packet-switched network, communicating with a host running a routing application to obtain routing data for communicating with a second voice, audio, video, text and/or multimedia communications host via the private packet-switched network pursuant to a predetermined protocol;
using the first voice, audio, video, text and/or multimedia communications host, communicating a desired user identifier to a user identifier translation application to obtain a corresponding host address of a desired second voice, audio, video, text and/or multimedia communications host to communicate voice, audio, video, text and/or multimedia data thereto pursuant to the predetermined protocol; and
communicating voice, audio, video, text and/or multimedia data on a peer-to-peer basis from the first communications host to the second voice, audio, video, text and/or multimedia communications host via the private packet-switched network using the host address pursuant to the predetermined protocol.

9. The method of claim 8, wherein the first voice, audio, video, text and/or multimedia communications host comprises a first voice and/or video communications host, the second voice, audio, video, text and/or multimedia communications host comprises a second voice and/or video communications host and communicating voice, audio, video, text and/or multimedia data on a peer-to-peer basis comprises communicating voice and/or video data on a peer-to-peer basis from the first voice and/or video data communications host to the second voice and/or video data communications host.

10. The method of claim 9, wherein the first voice and/or video communications host comprises a first voice communications host, the second voice and/or video communications host comprises a second voice communications host and communicating voice and/or video data on a peer-to-peer basis comprises communicating voice data on a peer-to-peer basis from the first voice data communications host to the second voice data communications host.

11. The method of claim 9, wherein the first voice and/or video communications host comprises a first video communications host, the second voice and/or video communications host comprises a second video communications host and communicating voice and/or video data on a peer-to-peer basis comprises communicating video data on a peer-to-peer basis from the first video data communications host to the second video data communications host.

12. A system for providing peer-to-peer voice, audio, video, text and/or multimedia communications between OSI layer 3 devices over an OSI layer 2 network, comprising:
An OSI layer 3 routing application running on an OSI layer 3 device, communicating OSI layer 3 routing data, to a plurality of OSI layer 3 devices over an OSI layer 2 network sufficient to enable peer-to-peer data communications between OSI layer 3 devices;
a plurality of OSI layer 3 communications devices, coupled with the OSI layer 2 network, having at least one uniform resource identifier for communication pursuant to an OSI layer 4 or higher protocol; and a directory service application running on an OSI layer 3 device coupled with the OSI layer 2 network, the directory service application operative to communicate a uniform resource identifier to a respective one of the plurality of OSI layer 3 communications devices in response to a user identifier identifying a system user.

13. A method for providing peer-to-peer voice, audio, video, text and/or multimedia communications between OSI layer 3 devices over an OSI layer 2 network communicating data pursuant to an OSI layer 3 protocol, comprising:
distributing OSI layer 3 routing data to a plurality of OSI layer 3 devices pursuant to an OSI layer 3 routing protocol, coupled to the OSI layer 2 network sufficient to enable peer-to-peer data communications therebetween pursuant to an OSI layer 4 or higher protocol, each of the plurality of OSI layer 3 communication devices having at least one uniform resource identifier for communication pursuant to the OSI layer 4 or higher protocol; and
communicating a uniform resource identifier by means of a directory service application running on an OSI layer 3 device coupled with the OSI layer 2 network to a respective one of the plurality of OSI layer 3 communications hosts in response to a user identifier identifying a system user.

14. A method for conducting peer-to-peer voice, audio, video, text and/or multimedia data communications between OSI layer 3 subscriber systems coupled with an OSI layer 2 network, comprising:
using a first OSI layer 3 subscriber system coupled with the OSI layer 2 network, communicating with an OSI layer 3 system coupled with the OSI layer 2 network and running an OSI layer 3 routing application to obtain OSI layer 3 routing data for communicating with a second OSI layer 3 subscriber system via the OSI layer 2 network pursuant to an OSI layer 3 protocol;
using the first OSI layer 3 subscriber system, communicating a desired user identifier to a directory service application coupled with the OSI layer 2 network to obtain a corresponding uniform resource identifier of a desired second OSI layer 3 subscriber system to communicate voice, audio, video, text and/or multimedia data thereto pursuant to an OSI layer 4 or higher protocol; and
communicating voice, audio, video, text and/or multimedia data from the first OSI layer 3 subscriber system to the desired second OSI layer 3 subscriber system via the OSI layer 2 network using the uniform resource identifier.

15. The method of claim 14, wherein communicating voice, audio, video, text and/or multimedia data comprises communicating voice and/or video data from the first OSI layer 3 subscriber system to the desired second OSI layer 3 subscriber system.

16. The method of claim 15, wherein communicating voice and/or video data comprises communicating voice data from the first OSI layer 3 subscriber system to the desired second OSI layer 3 subscriber system.

17. The method of claim 15, wherein communicating voice and/or video data comprises communicating video data from the first OSI layer 3 subscriber system to the desired second OSI layer 3 subscriber system.

18. The method of claim 14, wherein the predetermined OSI layer 3 protocol comprises one of an IP protocol, an IPv4 protocol, and an IPv6 protocol.

19. The method of claim 14, wherein the predetermined OSI layer 4 or higher protocol comprises one of an SIP protocol, an H323 protocol, a WWW protocol, an MGCP protocol, an MPEG protocol, an MP3 protocol, a TCP protocol and a UDP protocol.
